(19) United States
(12) Patent Application Publication
(10) Pub. No.: US 2004/0085569 A1
(43) Pub. Date: May 6, 2004

(54) Managing system for multi-function peripherals

(75) Inventor: Takanori Fukuhara, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/284,167

(22) Filed: Oct. 31, 2002

(51) Int. Cl. G06K 1/00; G06F 15/00

(52) U.S. Cl. 358/1.15; 358/1.14; 358/402

(57) ABSTRACT

A managing system for multi-function peripherals (MFPs) includes communication section for communicating with a plurality of computers connected to a communication network, a registration section which registers the plurality of computers on a group by group basis and also the computer of the manager of each group, a printing section which prints the printing information received from the computer and accompanied by group information indicating the group, a memory section which stores the number of sheets used for printing in the printing section by each of the groups, a clock section which measures the time and day, a setting section which sets conditions for transmitting information on the number of sheets used for printing and the time and day and also the addressee of transmission of the information, and a transmission section which transmits the information to the set addressee in response to satisfaction of the conditions.

### BACKGROUND OF THE INVENTION

1. Field of the Invention

This invention relates to a managing system for controlling the number of sheets of paper used for printing and that of sheets of paper used for copying by a multi-function peripheral (MFP) that can be connected to a communication network.

2. Description of the Related Art

Communication networks have been established to date in many business offices and personal computers (PC) available to office workers, and MFPs provided with copying and printing functions are connected thereto for communication purposes. Meanwhile, each office worker of a company belongs to a department of the company that is organized according to the type of work and the type of client. An MFP that is connected to a communication network can be normally accessed by office workers who belong to different divisions of the company. As the MFP is used for printing, the printing operation incurs an amount of expense that varies as the number of sheets used for the printing operation or the copying operation. Therefore, there must be a management system that can control the number of sheets of paper used for printing by each division of the company.

The number of sheets of paper used for printing by an MFP is normally controlled in a manner as described above. The manager of the MFP periodically checks the printer server that monitors the number of sheets of paper used for printing by each division to control the number of sheets of printing paper. More specifically, when the manager can use a printer server that can be controlled by means of a web and a protocol such as hyper text transfer protocol (HTTP), he or she controls the number of sheets of paper used for printing by accessing the printer server. The manager controls the number of sheets of paper used for printing by periodically printing the information on the number of sheets. Thus, the manager of each division is required to actively obtain information on the number of sheets of paper used by the division for printing for the purpose of managing sheets of printing paper. Therefore, the manager of each division has to actively obtain the information.

Likewise, the manager can control the number of sheets of paper used by each division for copying by so arranging that each office worker can use the MFP for copying only after making the latter recognize the card assigned to the division he or she belongs to. In the case of controlling the number of sheets of copying paper, the manager is required to actively obtain information on the number of sheets of paper used for copying as in the case of controlling the number of sheets of printing paper.

As pointed out above, the manager of each division is required to actively obtain information on the number of sheets of printing paper and that of sheets of copying paper, and in fact, this is a highly cumbersome operation.

### BRIEF SUMMARY OF THE INVENTION

It is the object of the present invention to provide a managing system for multi-function peripherals connected to a communication network that is designed to automatically notify the manager of information on the number of sheets of paper used for printing and that of sheets of paper used for copying on conditions that are set in advance.

According to the present invention, the above object is achieved by providing a managing system for MFPs comprising: a communication section which communicates with a plurality of computers connected to a communication network; a registration section which registers the plurality of computers, on a group by group basis and also the computer of the manager of each group; a printing section which prints the printing information received from the computer and accompanied by group information indicating the group; a memory section which stores the number of sheets of paper used for printing in the printing section by each of the groups; a clock section which measures the time and day; a setting section which sets conditions for transmitting information on the number of sheets of paper used for printing stored in the memory section and the time and day and also the addressee of transmission of the information; and a transmission section which transmits the information to the set addressee in response to satisfaction of the conditions set by the setting section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram of the configuration of the network of an embodiment of the invention;

FIG. 2 is an external view of an MFP;

FIG. 3 is a block diagram of an MFP, illustrating principal components thereof;

FIG. 4 is an illustration of data that can be stored in the memory section;

FIG. 5 is an illustration of other data that can be stored in the memory section;

FIG. 6 is an illustration of still other data that can be stored in the memory section; and

FIG. 7 is a flowchart of the processing operation of the CPU.

### DETAILED DESCRIPTION OF THE INVENTION

Now, the present invention will be described by referring to the accompanying drawing that illustrates an embodiment of the invention.

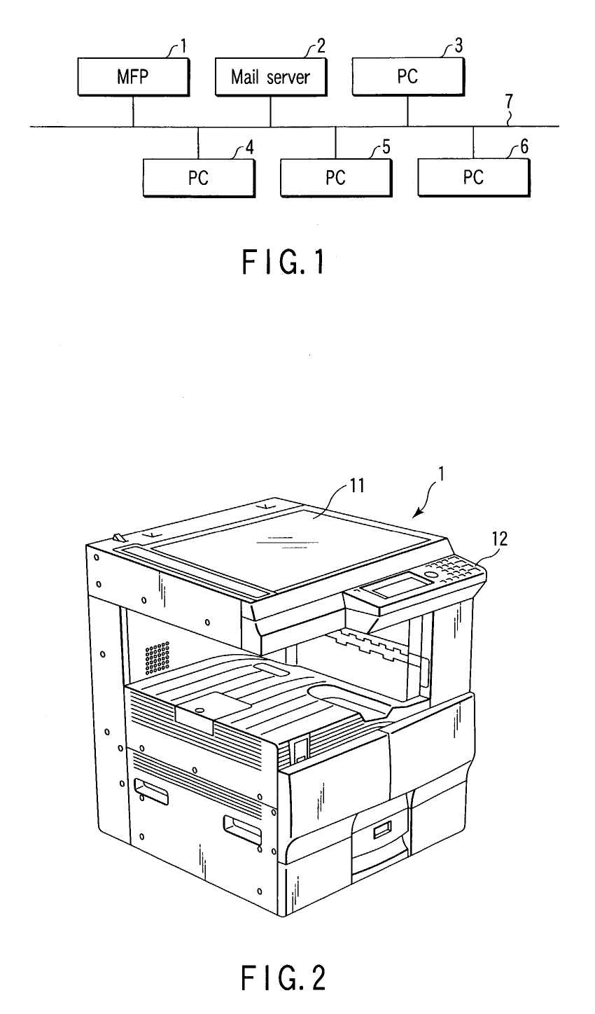

FIG. 1 is a block diagram of the configuration of the network, wherein MFP 1, mail server 2 and PC 3 through 6 are connected to a local area network (LAN) 7. The mail server 2 controls the mail addresses of the PC connected to the LAN 7 and also transmissions and receptions of electronic mails.

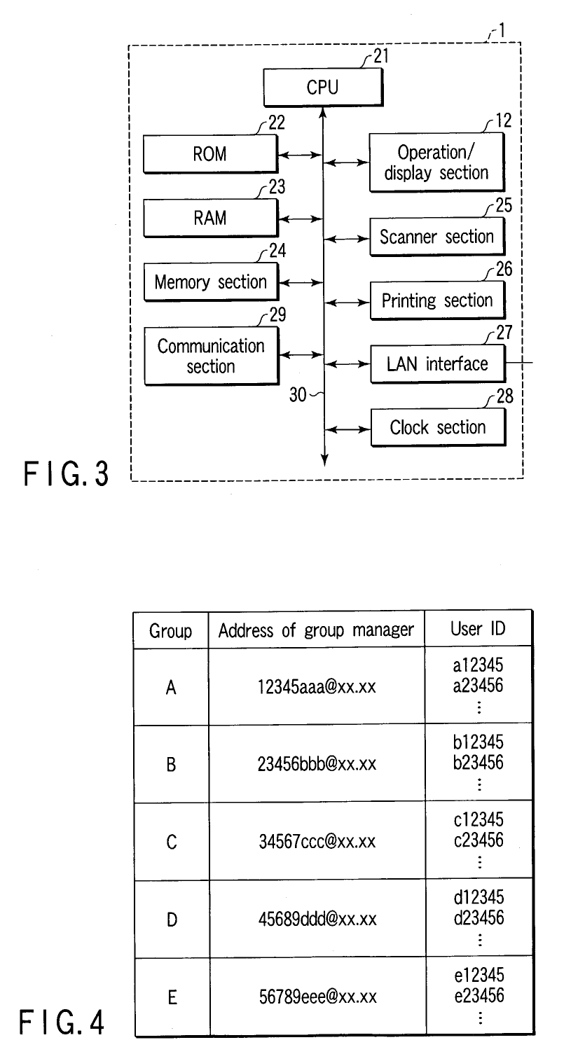

FIG. 2 is an external view of an MFP and FIG. 3 is a block diagram of an MFP, illustrating principal components thereof. The MFP 1 is provided with an original table, on which an original is placed, and an operation/display section 12.

The MFP 1 comprises, as principal components thereof a CPU 21, a ROM 22, a RAM 23, a memory section 24, a scanner section 25, a printing section 26, a LAN interface 27, an operation/display section 12, a clock section 28 and a communication section 29.

The CPU 21, the ROM 22, the RAM 23, the memory section 24, the scanner section 25, the printing section 26, the LAN interface 27, the operation/display section 12, the clock section 28 and the communication section 29 are connected to each other by way of a bus line 30.

The CPU 21 controls the component sections of the MFP 1 in a coordinated manner according to the control program stored in the ROM 22 so as to make the MFP 1 operate properly.

The ROM 22 stores the control program to be used by the CPU 21. The control program includes the general control program of the MFP 1 and also an additional control program for preparing and transmitting an electronic mail to a set addressee when predetermined conditions are met for the transmission. The contents of an electronic mail to be prepared by the additional control program will be described hereinafter.

The RAM 23 has areas including work areas for storing various pieces of information necessary for the CPU 21 to execute various processing operations.

The memory section 24 is typically provided with a hard disk drive (HDD) and adapted to store data whose contents will be described by referring to FIGS. 4 through 6 hereinafter, and to temporarily store printing information and image information it receives. The HDD of the memory section 24 may be replaced by a DRAM having a large memory capacity.

FIG. 4 is an illustration of a table (the registration section) showing the groups typically registered on a division by division basis. As shown in FIG. 4, each division is divided into five groups of A, B, C, D and E. The mail address of the manager of each group who is responsible for controlling the number of sheets of paper used for printing and the number of sheets of paper used for copying is defined. The set of the mail address of a manager can be modified freely by inputting data by way of the operation/display section 12 according to a predetermined procedure. A user ID is assigned to each group and used as group information on the PCs that can be used by the office workers of the division. Note that it is assumed here that the manager of the group A is responsible for controlling the number of sheets of paper used for printing and that of sheets of paper used for copying in the MFP 1 including those used by his or her own group.

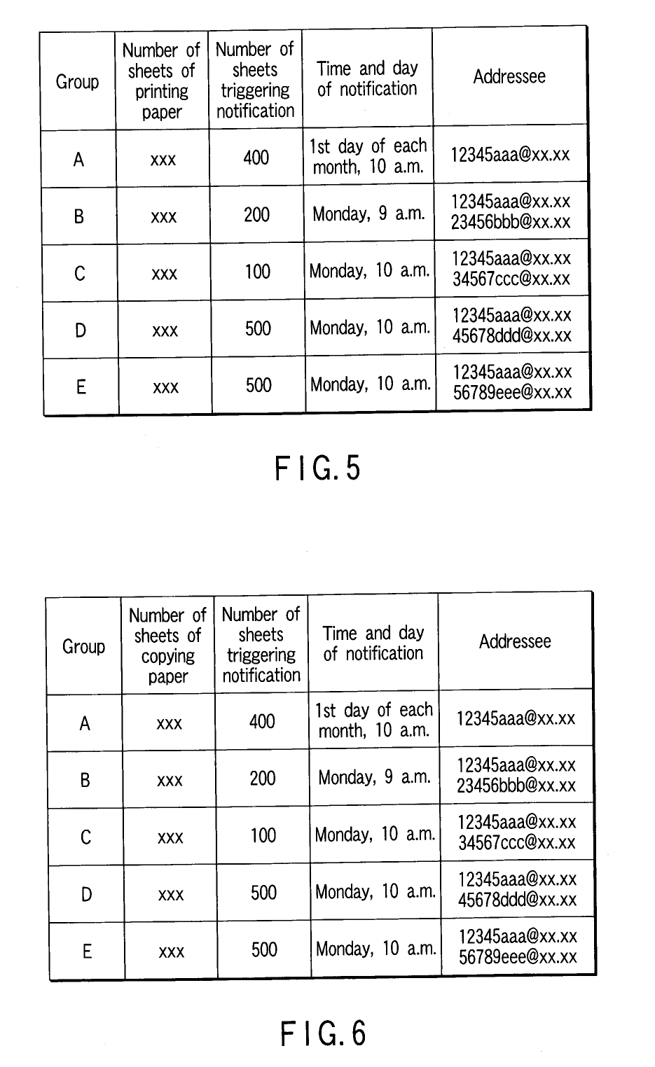

FIG. 5 is an illustration of a table of data defined on the number of sheets of paper used for printing by each group (the setting section and the memory section for storing the number of sheets of paper used for printing on a group by group basis). As shown in FIG. 5, the number of sheets of paper used for printing, the number of sheets of paper used for printing that triggers transmission of an electronic mail to the manager in order to notify the latter thereof, the time and day at which the notification is to be given and the mail address which is to be transmitted are defined for each group in the table. For example, the number of sheets of paper used for printing that triggers a notification is 100, the time and day of notification is Monday, 9 a.m. for Group C and the addressees are the managers of Group A and Group C. The MFP 1 identifies the group based on the user ID that is added to the printing information it receives.

FIG. 6 is an illustration of a table of data defining the number of sheets of paper used for copying by each group (the setting section and the memory section for storing the number of sheets of paper used for copying on a group by group basis). As shown in FIG. 6, the number of sheets of paper used for copying, the number of sheets of paper used for copying that triggers transmission of an electronic mail to the manager in order to notify the latter thereof, the time and day at which the notification is to be given and the mail address which is to be transmitted are defined for each group in the table. For example, the number of sheets of paper used for copying that triggers a notification is 100, the time and day of notification is Monday, 9 a.m. for Group C and the addressees are the managers of Group A and Group C. In order for the MFP 1 to identify the group that used the sheets of paper for copying, it may be so arranged that the MFP 1 permits a copying operation only when it receives from the operation/display section 12 the code number of the group that is going to use the MFP 1 for copying as group information. Alternatively, the MFP 1 may be provided with a card reader and it permits a copying operation only when the card reader reads the identification number on the card and identifies the group.

The operation/display section 12 includes an operation section adapted to receive inputs of various commands given by the user to the CPU 21 and a display section for displaying various pieces of information to be notified to the user under the control of the CPU 21.

The scanner section 25 receives a predetermined instruction from the operation/display section 12 and reads the image of the original placed on the original table 11 when the cover (not shown) of the original table 11 is closed.

The printing section 26 prints the printing information received by way of the LAN 7 or the image information read by the scanner section 25 on a sheet of recording paper.

The LAN interface 27 is connected to a communication line to be connected to the LAN 7. Therefore, while the MFP is in operation for communication, it operates as a receiving section when the MFP receives various pieces of information and as a transmitting section when the MFP transmits various pieces of information.

The clock section 28 continually operates for timing and outputs time information indicating the current time and day.

The communication section 29 is connected to the LAN 7 by way of the LAN interface 27. The communication section 29 controls communications with the main server 2 and the PCs 3 through 6 connected to the LAN 7.

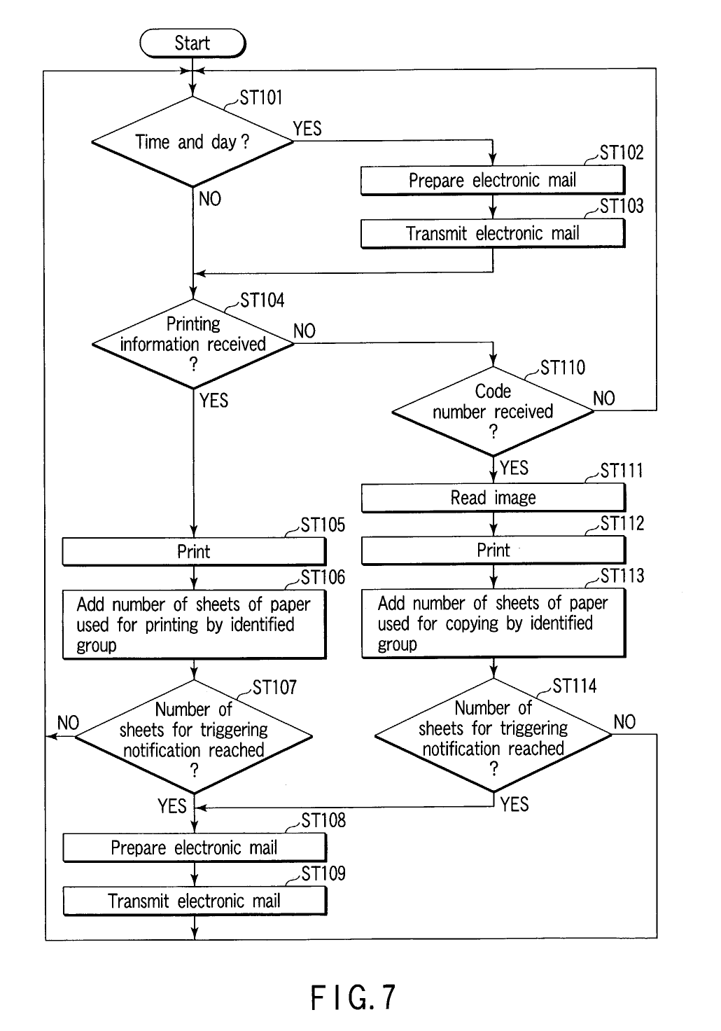

Now, the processing operation of the CPU 21 will be described by referring to the flowchart of FIG. 7. As the power switch is turned ON and power is supplied to the MFP, the CPU 21 starts a processing operation.

Firstly in Step ST101, the CPU 21 determines if the time information output from the clock section 28 indicates the time and day defined for any of the groups A through E or not, so as to notify the relevant group, or each of the relevant groups, of the number of sheets of paper used for printing and the number of sheets of paper used for copying. If it is determined that the time information indicates the time and day defined for any of the groups, the CPU 21 prepares an electronic mail to be transmitted to the addressee defined for the relevant group or each of the relevant groups in Step ST102. The electronic mail contains the time and day when the electronic mail is prepared, the number of sheets of paper used for printing and that of sheets of paper used for copying by the group. Then, the CPU 21 transmits the electronic mail to the group in Step ST103.

If, on the other hand, the CPU determines in Step ST101 that the time information does not indicate the time and day defined for any of the groups or it transmits an electronic mail in Step ST103, it determines in Step ST104 if it receives printing information by way of the LAN 7 or not. If it is determined that printing information is received, the CPU 21 performs a printing operation according to the printing information in Step ST105. Then, the CPU 21 proceeds to Step ST106 and adds the number of sheets of paper used for the printing operation to the number of sheets of paper used for printing by the group identified by the user ID contained in the printing information.

Then, in Step ST107, the CPU 21 determines if the number of sheets of paper used for printing by the group has reached the number of sheets of paper that triggers a notification or not. If it is determined that the number of sheets of paper used for printing has reached the number of sheets of paper that triggers a notification, the CPU 21 prepares an electronic mail to be transmitted to the addressee defined for the group to be notified in Step ST108. Then, in Step ST109, the CPU 21 transmits the electronic mail.

On the other hand, if it is determined in Step ST104 that printing information is not received, the CPU 21 determines in Step ST110 if it received a code number or not (reception section which receives group information). If it is determined in Step ST110 that it received a code number, the CPU receives the fact that a predetermined key is input from the key input section in Step ST111 and subsequently reads the image of the original placed on the original table 11 by controlling the scanner section 25. The CPU executes an operation of printing the image in Step ST112. Subsequently, in Step ST113, the CPU adds the number of sheets of paper used for the copying operation to that of the number of sheets of paper used for copying by the group identified from the code number.

Then, in Step ST114, the CPU 21 determines if the number of sheets of paper used for copying by the group has reached the number of sheets of paper that triggers transmission of a notification to the group or not. If it is determined that the former reached the latter, the CPU 21 proceeds to Step ST108, where it prepares an electronic mail, and transmits the electronic mail in Step ST109.

If, on the other hand, it is determined in Step ST110 that the code number is not received by the CPU 21, the CPU 21 returns to Step ST101 and determines if the time information indicates the time and day defined for transmission of a notification to any of the groups or not. Thus, the CPU 21 keeps the MFP 1 in a standby state until it receives printing information or a code number so that it can determine if the time and day defined for transmission of a notification to any of the groups comes or not.

When it is determined that the number of sheets of paper used for printing has not reached the defined number in Step ST107 or the number of sheets of paper used for copying has not reached the defined number in Step S114 or when an electronic mail is transmitted in Step ST109, the CPU 21 returns to Step ST101. Note that the processing operation of the CPU 21 is terminated when the power switch of the MFP 1 is turned OFF.

Therefore, for example, as the power switch of the MFP 1 is turned ON on Monday, 9 a.m., an electronic mail for notifying the group C of the time and day, the number of sheets of paper used for printing, that of sheets of paper used for copying and so on is automatically prepared because the time and day for transmitting a notification to the group C has come. Then, the electronic mail is automatically transmitted to PCs of the managers of the groups A and C defined as the addressees of the electronic mail by the MFP 1.

If, for example, the number of sheets of paper used for printing by the group C reaches 100 when a person belonging to the group C is consuming sheets of paper for printing at the MFP 1, an electronic mail showing the time and day and the fact that the number of sheets of paper used for printing by the group C has reached 100 is automatically prepared and transmitted from the MFP1 to the PCs of the managers of the groups A and C defined as the addressees of the electronic mail.

Thus, with this embodiment of MFP1, time and day is defined for each group and, when the defined time and day comes, an electronic mail showing the number of sheets of paper used for printing by the group or the number of sheets of paper used for copying by the group is automatically transmitted to the PCs of the managers specified as the addressees of the group.

Additionally, a number of sheets of printing paper and a number of sheets of copying paper are defined for each group and, when the number of sheets of paper used for printing reaches the defined number, an electronic mail showing the number of sheets of paper used for printing and the time and day when the defined number of sheets has been reached is automatically transmitted to the PCs of the managers defined as the addressees of the group.

Thus, the manager can automatically obtain information relating to the number of sheets of paper used for printing and the number of sheets of paper used for copying by the group of own managing at the defined time and day or when the number of sheets triggers transmission of a notification. Therefore, the managing of MFP1 can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A managing system for multi-function peripherals (MFPs) comprising:
a communication section which communicates with a plurality of computers connected to a communication network;
a registration section which registers the plurality of computers on a group by group basis and also the computer of the manager of each group;
a printing section which prints the printing information received from the computer and accompanied by group information indicating the group;
a memory section which stores the number of sheets of paper used for printing in the printing section by each of the groups;
a clock section which measures the time and day;
a setting section which sets conditions for transmitting information on the number of sheets of paper used for printing stored in the memory section and the time and day and also the addressee of transmission of the information; and
a transmission section which transmits the information to the set addressee in response to satisfaction of the conditions set by the setting section.

2. The managing system for MFPs according to claim 1, wherein the information on the number of sheets of paper used for printing and the time and day are contained in an electronic mail prepared for transmission.

3. The managing system for MFPs according to claim 1, wherein the conditions are those relating to time and day.

4. The managing system for MFPs according to claim 1, wherein the conditions are those relating to the number of sheets of printing paper.

5. The managing system for MFPs according to claim 1, further comprising an operation section for altering the addressee set by the setting section.

6. A managing system for multi-function peripherals (MFPs) comprising:
a communication section which communicates with a plurality of computers connected to a communication network;
a registration section which registers the plurality of computers on a group by group basis and also the computer of the manager of each group;
a reception section which receives group information indicating the group registered by the registration section;
a scanner section which reads the image of the original placed at a predetermined position after receiving the group information;
a printing section which prints the image;
a memory section which stores the number of sheets of paper used for printing in the printing section by each of the groups;
a clock section which measures the time and day;
a setting section which sets conditions for transmitting information on the number of sheets of paper used for printing stored in the memory section and the time and day and also the addressee of transmission of the information; and
a transmission section which transmits the information to the set addressee in response to satisfaction of the conditions set by the setting section.

7. The managing system for MFPs according to claim 6, wherein the information on the number of sheets of paper used for printing and the time and day are contained in an electronic mail prepared for transmission.

8. The managing system for MFPs according to claim 6, wherein the conditions are those relating to time and day.

9. The managing system for MFPs according to claim 6, wherein the conditions are those relating to the number of sheets of printing paper.

10. The managing system for MFPs according to claim 6, further comprising an operation section for altering the addressee set by the setting section.

11. A managing method for multi-function peripherals (MFPs), comprising:
receiving printing information accompanied by group information indicating registered groups from a plurality of computers connected to a network;
printing the printing information;
storing the number of sheets of paper used for printing by each of the groups;
measuring the time and day;
judging satisfaction of conditions for transmitting information on the number of sheets of paper used for printing and the time and day; and
transmitting the information to the computer of the manager of each group set upon judging satisfaction of the conditions for transmission.

12. The managing method for MFPs according to claim 11, wherein the information on the number of sheets of paper used for printing and the time and day are contained in an electronic mail prepared for transmission.

13. The managing method for MFPs according to claim 11, wherein the conditions are those relating to time and day.

14. The managing method for MFPs according to claim 11, wherein the conditions are those relating to the number of sheets of printing paper.

15. The managing method for MFPs according to claim 11, further comprising altering the addressee upon receiving a predetermined operation.

16. A managing method for multi-function peripherals (MFPs) comprising:
receiving group information indicating registered groups;
reading the image of the original placed at a predetermined position;
printing the image;
storing the number of sheets of paper used for printing by each of the groups;
measuring the time and day;
judging satisfaction of conditions for transmitting information on the number of sheets of paper used for printing and the time and day; and
transmitting the information to the computer of the manager of each group set upon judging satisfaction of the conditions for transmission.

17. The managing method for MFPs according to claim 16, wherein the information on the number of sheets of paper used for printing and the time and day are contained in an electronic mail prepared for transmission.

18. The managing method for MFPs according to claim 16, wherein the conditions are those relating to time and day.

19. The managing method for MFPs according to claim 16, wherein the conditions are those relating to the number of sheets of printing paper.

20. The managing method for MFPs according to claim 16, further comprising altering the addressee upon receiving a predetermined operation.
